(19) United States
(12) Patent Application Publication
(10) Pub. No.: US 2024/0084466 A1
(43) Pub. Date: Mar. 14, 2024

(54) HIGH SURFACE AREA, HIGH POROSITY IRIDIUM-BASED CATALYST AND METHOD OF MAKING

(71) Applicant: UOP LLC, Des Plaines, IL (US)

(72) Inventors: Zhanyong Li, Schaumburg, IL (US); Chunqing Liu, Arlington Heights, IL (US); Shurong Yang, Naperville, IL (US); Dennis F. van der Vliet, Skokie, IL (US); Gavin P. Towler, Inverness, IL (US); Jeffery C. Bricker, Buffalo Grove, IL (US)

(21) Appl. No.: 18/313,719

(22) Filed: May 8, 2023

Related U.S. Application Data
(60) Provisional application No. 63/374,932, filed on Sep. 8, 2022.

(51) Int. Cl. C25B 11/091; C01G 55/00; C25B 11/075

(52) U.S. Cl. CPC C25B 11/091; C01G 55/004; C25B 11/075; C01P 2004/04; C01P 2004/24; C01P 2006/12; C01P 2006/14; C01P 2006/40; C25B 1/04

(57) ABSTRACT

An iridium-based catalyst and method of making the catalyst are described. The catalyst comprises a catalytic material comprising iridium oxide or a mixture of iridium and iridium oxide nanoplates. It may have a BET surface area of at least 50 m²/g and a pore volume of at least 0.10 cc/g. The nanoplates are less than 50 nm thick. The catalyst is made using organic and inorganic structure directing agents.

### BACKGROUND

This application claims priority to U.S. Provisional Patent Application Ser. No. 63/374,932 filed on Sep. 8, 2022, the entirety of which is incorporated herein by reference.

Hydrogen as an energy vector for grid balancing or power-to-gas and power-to-liquid processes plays an important role in the path toward a low-carbon energy structure that is environmentally friendly. Water electrolysis produces high quality hydrogen by electrochemical splitting of water into hydrogen and oxygen; the reaction is given by Eq. 1 below. The water electrolysis process is an endothermic process and electricity is the energy source. Water electrolysis has zero carbon footprint when the process is operated by renewable power sources, such as wind, solar, or geothermal energy. The main water electrolysis technologies include alkaline electrolysis, proton exchange membrane (PEM) water electrolysis (PEMWE as shown in FIG. 1), anion exchange membrane (AEM) water electrolysis (AEMWE as shown in FIG. 2), and solid oxide water electrolysis.

As shown in FIG. 1, in a PEMWE system 100, an anode 105 and a cathode 110 are separated by a solid PEM electrolyte 115 such as a sulfonated tetrafluoroethylene based cofluoropolymer sold under the trademark Nafion® by Chemours company. The anode and cathode catalysts typically comprise IrO₂ and Pt, respectively. At the positively charged anode 105, pure water 120 is oxidized to produce oxygen gas 125, electrons (e⁻), and protons; the reaction is given by Eq. 2. The protons are transported from the anode 105 to the cathode 110 through the PEM 115 that conducts protons. At the negatively charged cathode 110, a reduction reaction takes place with electrons from the cathode 110 being given to protons to form hydrogen gas 130; the reaction is given by Eq. 3. The PEM 115 not only conducts protons from the anode 105 to the cathode 110, but also separates the H₂ gas 130 and O₂ gas 125 produced in the water electrolysis reaction. PEM water electrolysis is one of the favorable methods for conversion of renewable energy to high purity hydrogen with the advantage of compact system design at high differential pressures, high current density, high efficiency, fast response, small footprint, lower temperature (20-90° C.) operation, and high purity oxygen byproduct. However, one of the major challenges for PEM water electrolysis is the high capital cost of the cell stack comprising expensive acid-tolerant stack hardware such as the Pt-coated Ti bipolar plates, expensive noble metal catalysts required for the electrodes, as well as the expensive PEM.

Water electrolysis reaction:2H₂O→2H₂+O₂ (1)

Oxidation reaction at anode for PEMWE:2H₂O→O₂+4H⁺+4e⁻ (2)

Reduction reaction at cathode for PEMWE:2H⁺+2e⁻→H₂ (3)

AEMWE is a developing technology. As shown in FIG. 2, in the AEMWE system 200, an anode 205 and a cathode 210 are separated by a solid AEM electrolyte 215. Typically, a water feed 220 with an added electrolyte such as dilute KOH or K₂CO₃ or a deionized water is fed to the cathode side. The anode and cathode catalysts typically comprise platinum metal-free Ni-based or Ni alloy catalysts. At the negatively charged cathode 210, water is reduced to form hydrogen 225 and hydroxyl ions by the addition of four electrons; the reaction is given by Eq. 4. The hydroxyl ions diffuse from the cathode 210 to the anode 205 through the AEM 215 which conducts hydroxyl ions. At the positively charged anode 205, the hydroxyl ions recombine as water and oxygen 230; the reaction is given by Eq. 5. The AEM 215 not only conducts hydroxyl ions from the cathode 210 to the anode 205, but also separates the H₂225 and O₂ 230 produced in the water electrolysis reaction. The AEM 215 allows the hydrogen 225 to be produced under high pressure up to about 35 bar with very high purity of at least 99.9%.

Reduction reaction at cathode for AEMWE:4H₂O+4e⁻→2H₂+4OH⁻ (4)

Oxidation reaction at anode for AEMWE:4OH⁻→2H₂O+O₂+4e⁻ (5)

IrO₂ is widely accepted as the most efficient oxygen evolution reaction (OER) catalyst in PEM-WE due to its high activity and stability. However, its limited supply and high price limits its use.

Therefore, there is a need for a high activity IrO₂ which can be used at a lower loading while providing comparable or improved performance compared to commercial IrOₓ catalysts.

### BRIEF DESCRIPTION OF THE DRAWINGS

FIG. 1 is an illustration of a PEMWE system.

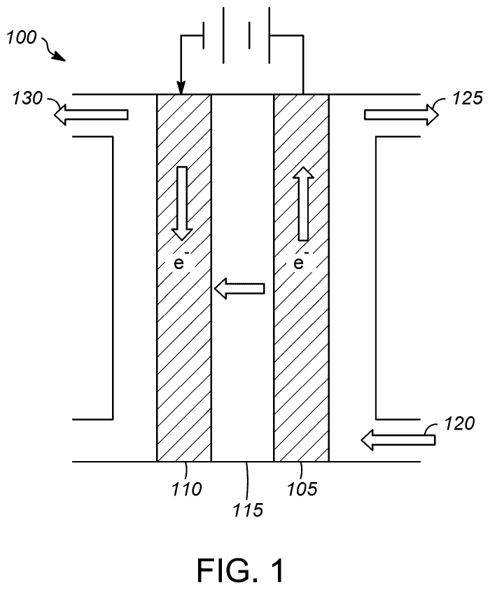

FIG. 2 is an illustration of an AEMWE system.

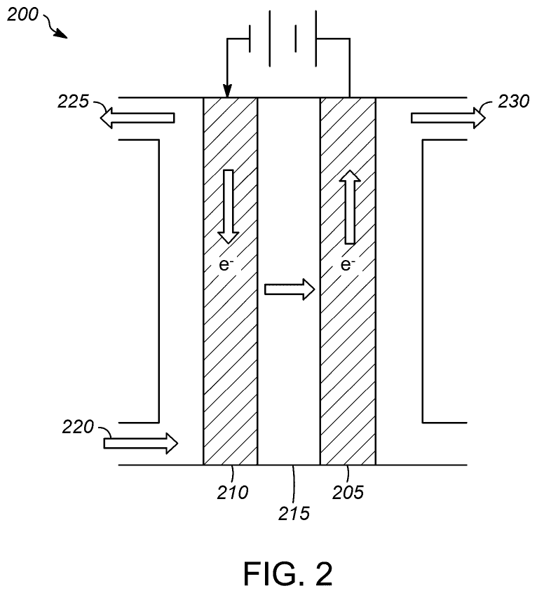

FIG. 3A-B are Scanning Transmission Electron Microscope (STEM) images of an IrOₓ-bypiridine catalyst.

FIG. 4 is a STEM image of an IrOₓ-cysteamine catalyst.

FIG. 5 is graph showing a comparison of OER activity of (a) a commercial catalyst; (b) IrOₓ-cysteamine; and (c) IrOₓ-bipyridine according to the present invention.

FIG. 6 is a graph showing the polarization curves of a water electrolysis cell comprising of (a) a commercial catalyst; (b) IrOₓ_cysteamine; and (c) IrOₓ-bipyridine made according to the present invention.

### DESCRIPTION

A high loading of about 2 mg/cm² IrOₓ OER catalyst in the anode layer of the catalyst-coated membrane (CCM) for PEMWE is required for the current state-of-art PEM water electrolyzer to maintain high performance and high stability. Reducing the IrOₓ OER catalyst loading to 0.5 mg/cm² or less results in low durability and low electrolyzer efficiency due to poor mechanical stability of the very thin IrOₓ-based anode catalyst layer and defects in the CCM. The current state-of-the-art commercial IrOₓ catalyst utilizing spherical IrOₓ nanoparticles has less contact among the adjacent particles and therefore forms defects easily in the very thin anode coating layer on the PEM. The low loading of IrOₓ OER catalyst in the anode layer of the CCM leads to a defective coating layer and poor electrical contact between the catalyst coating layer and the porous transport layer (PTL). Therefore, the low-loading catalyst coating layer with defects causes high cell/stack voltage resulting in low electrolyzer efficiency. The BET surface area of several commercial IrOₓ catalysts was measured, and all of the catalysts had BET surface areas below 25 m²/g. The pore volume of those commercial IrOₓ catalysts was also measured, and the pore volume was 0.05 cc/g or less.

The current invention provides a solution to reduce IrOₓ loading significantly without the loss of performance and durability. A family of new IrO₂ catalysts for oxygen evolution reaction (OER) in a PEMWE or AEMWE has been developed. The highly active iridium-based materials have high porosity, high surface area, and a nanoplate morphology. A nanoplate has at least one dimension (thickness) at the nanoscale of about 1 nm to about 50 nm and an aspect ratio of at least 5. A CCM made using the high surface area, high porosity, high activity nanoplate IrO₂ as the OER catalyst had comparable performance to a commercial IrO₂ catalyst at a lower IrO₂ loading.

The morphology of the IrO₂ is important, particularly when the IrOₓ loading in the anode catalyst layer is low (e.g., 0.5 mg/cm² or less). Commercial IrO₂ have a spherical morphology, which introduces too many defects into the catalyst layer to maintain the activity when the IrO₂ loading is lowered. The defects in the thin IrO₂ catalyst coating layer are normally the areas without the catalyst coating due to less overlap among the adjacent particles. In contrast, a nanoplate morphology maintains the continuous, well-connected catalyst layer structure in the thin catalyst coating layer, resulting in low resistance and good performance. The IrOₓ with the desired nanoplate morphology has a higher tendency to form a continuous anode catalyst layer without pinholes in the CCM. The continuous catalyst layer structure provides better contact of the IrOₓ particles with each other in the anode catalyst layer, leading to a lower resistance. A uniform anode catalyst layer also helps to maintain its low contact resistance with the porous transport layer.

The PEM electrolyzer testing results (discussed below) showed that a CCM with 0.17 mg/cm² IrO₂ loading of the present catalyst exhibited comparable performance to a commercial IrO₂ with 1.0 mg/cm² loading under the same testing conditions.

The iridium-based catalyst comprises a catalytic material comprising iridium oxide or a mixture of iridium and iridium oxide nanoplates.

The catalyst has a BET surface area of at least 50 m²/g, or at least 100 m²/g, or at least 150 m²/g, or in a range of 50 m²/g to 800 m²/g, or 50 m²/g to 700 m²/g, or 50 m²/g to 600 m²/g, or 50 m²/g to 500 m²/g, or 50 m²/g to 400 m²/g, or 50 m²/g to 300 m²/g.

The catalyst has a pore volume of at least 0.10 cc/g, or at least 0.20 cc/g, or at least 0.30 cc/g, or in a range of 0.10 cc/g to 0.70 cc/g, in a range of 0.10 cc/g to 0.60 cc/g, or in a range of 0.10 cc/g to 0.50 cc/g, or in a range of 0.10 cc/g to 0.40 cc/g.

The catalyst has a nanoplate structure in which the thickness of the nanoplate is less than 50 nm, or less than 20 nm, or less than 10 nm, or less than 5 nm.

In one embodiment, the catalyst has a BET surface area in a range of 50 m²/g to 800 m²/g and a pore volume is in a range of 0.20 cc/g to 0.70 cc/g.

The catalyst is made using an organic structure directing agent and an inorganic structure directing agent. The organic structure directing agent coordinates to the Ir precursor, forming a coordination complex. The presence of the coordinating ligands affects the packing of the Ir species of the material in the solid state because of the steric of the organic structure directing agent. Upon calcination in the molten inorganic structure directing agent environment to remove the organic structure directing agent, a novel IrOₓ material with a unique morphology is obtained because of the unique solid-state packing of the Ir species. The organic structure directing agent and the inorganic structure directing agent play an important role in dictating the morphology of the final IrOₓ material. During the synthesis, a solution is made of an iridium-based precursor in a solvent. An organic structure directing template and an inorganic structure directing template are added to the solution. The solution is heated, and the solvent is evaporated forming a solid residue, in which the inorganic structure directing agent hosts the Ir-species with the organic structure directing agent in its coordination sphere. The solid residue is dried and calcined to form the iridium-based catalyst. The properties of the catalyst are described above.

The organic structure directing template includes multiple heteroatoms, such as oxygen, nitrogen, sulfur and/or phosphorus, which can coordinate to the Ir metal center during the heating process. Suitable organic structure directing templates include, but are not limited to, cysteamine, 2,2′-bipyridine, terpyridine, tris(2-aminoethyl)amine, ethylenediamine, 3-aminopropane-1-thiol, glycine, ethanolamine, polyethylene imine, 1,2-bis(diphenylphosphino)ethane, or combinations thereof.

The inorganic structure directing agents are in a molten state at the calcination temperatures. For example, when the material is calcined at 400° C., LiNO₃ and NaNO₃ can be used. When the material is calcined at 800° C., NaCl can be used. Mixtures of inorganic structure directing agents can be used to obtain a desired intermediate temperature. Suitable inorganic structure directing template include, but are not limited to, NaNO₃, KNO₃, LiNO₃, NaCl, KCl or combinations thereof.

Suitable heating temperatures include, but are not limited to, 30° C. to 200° C., or 30 to 150° C., or 30 to 100° C., or 30 to 80° C., or 50 to 200° C., or 50 to 150° C., or 50 to 100° C., or 50 to 80° C. Suitable heating times include, but are not limited to 10 min to 240 min, or 10 min to 180 min, or 10 min to 120 min, or 10 min to 60 min, or 20 min to 240 min, or 20 min to 180 min, or 20 min to 120 min, or 20 min to 60 min, or 30 min to 240 min, or 30 min to 180 min, or 30 min to 120 min, or 30 to 60 min.

Suitable drying temperatures include, but are not limited to, 60° C. to 150° C., or 60° C. to 100° C., or 80 to 150° C., or 80 to 100° C. Suitable drying times include, but are not limited to, 20 min to 600 min, or 20 min to 600 min, 20 min to 300 min, or 20 min to 240 min, or 20 min to 120 min, or 30 min to 600 min, 30 min to 300 min, or 30 min to 240 min, or 30 to 120 min.

Suitable calcining temperatures include, but are not limited to, 300° C. to 600° C., or 300 to 500° C., or 300 to 450° C., or 350° C. to 600° C., or 350 to 500° C., or 350 to 450° C. Suitable calcining times include, but are not limited to, 20 min to 120 min, or 20 min to 60 min, or 30 min to 120 min, or 30 min to 60 min.

In some embodiments, the iridium-based catalyst may be washed with water, or an organic solvent, or combinations thereof. Suitable organic solvents include, but are not limited to, alcohols, aldehydes, organic acids, ketones, ethers, acetates, or combinations thereof.

After washing, the catalyst may be dried to remove the water and/or organic solvent. The drying can be done by heating or freeze drying, for example. Suitable drying temperatures after washing include, but are not limited to, −50° C. to 100° C., or −50° C. to 80° C., or −50° C. to 50° C., or −20° C. to 100° C., or −20° C. to 80° C., or −20° C. to 50° C. Suitable drying times include, but are not limited to, 20 min to 500 min, or 20 min to 400 min, or 20 min to 360 min, or 20 min to 300 min, or 50 min to 500 min, or 50 min to 400 min, or 50 min to 360 min, or 50 min to 300 min, or 100 min to 500 min, or 100 min to 400 min, or 100 min to 360 min, or 100 min to 300 min.

### EXAMPLES

### Example 1: Synthesis of Iridium Oxide Thin Nanoplate Catalyst IrO_{X}-Bipyridine

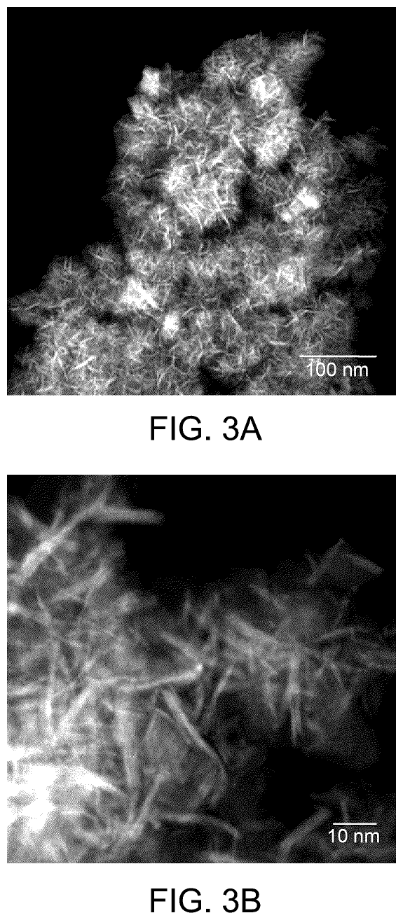

A sample of 200 mg IrCl₃ hydrate was mixed with 10 mL water in a flask and subjected to sonication for 30 minutes to fully dissolve the solid at room temperature. Subsequently, 203 mg of 2,2′-bipyridine was added to the solution, along with 4 g of NaNO₃. The system was heated to 80° C. in a water bath for 1 hour with constant stirring. The solvent was evaporated off in the same water bath, which took another hour. The recovered solid was ground to fine powders and transferred to a calcination dish. It was dried at 110° C. for 30 minutes in a calcination oven before the temperature was raised to 450° C. at 2° C./min. The temperature was held at 450° C. for 30 minutes before cooling down in air to 50° C. Upon washing with H₂O and methanol, 120 mg of IrOₓ-bipyridine catalyst was recovered as a black solid after drying in air at room temperature. The IrOₓ-bipyridine catalyst was characterized by STEM. The STEM images as shown in FIGS. 3A-B1 established that IrOₓ-bipyridine catalyst has thin nanoplate morphology.

### Example 2: Synthesis of Iridium Oxide Thin Nanoplate Catalyst IrOₓ-Cysteamine

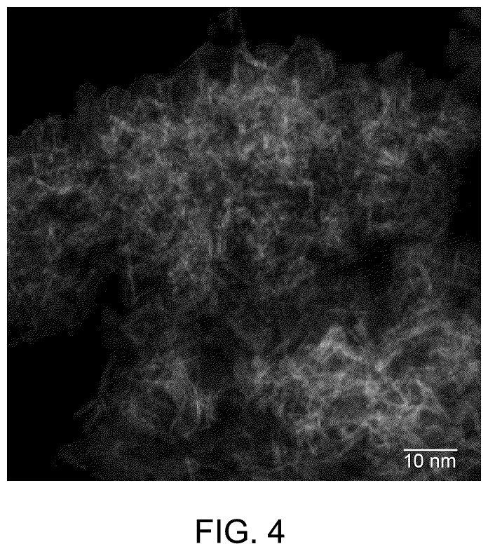

A sample of 200 mg IrCl₃ hydrate was mixed with 10 mL water in a flask and subjected to sonication for 30 minutes to fully dissolve the solid at room temperature. Subsequently, 100 mg of cysteamine was added to the solution, along with 4 g of NaNO₃. The system was heated to 80° C. in a water bath for 1 hour with constant stirring. The solvent was evaporated off in the same water bath, which took about another hour. The recovered solid was ground to fine powders and transferred to a calcination dish. It was dried at 110° C. for 30 minutes in a calcination oven before the temperature was raised to 450° C. at 2° C./min. The temperature was held at 450° C. for 30 minutes before cooling down in air to 50° C. Upon washing with H₂O and methanol, 123 mg of IrOₓ-cysteamine catalyst was recovered as a black solid after drying in air at room temperature. The IrOₓ-cysteamine catalyst was characterized by STEM. The STEM image as shown in FIG. 4 demonstrated that IrOₓ-cysteamine catalyst has thin nanoplate morphology.

### Example 3: Intrinsic Oxygen Evolution Reaction (OER) Activity Evaluation of Three Iridium-Based Catalysts

A commercial IrO₂ catalyst and the two new iridium-based catalysts made in Example 1 and Example 2 were evaluated in a benchtop electrochemical testing unit. The catalyst ink was prepared by mixing the catalyst and Nafion® ionomer (5 wt % in alcohol) in a mixture of deionized water and ethyl alcohol. The mixture was finely dispersed using an ultrasonication bath. An aliquot of 10 uL of the prepared ink was drop-casted on a glassy carbon working electrode. After drying in air for 20 minutes, the electrode with the drop-casted catalyst was placed in an electrochemical testing cell, along with a counter electrode made of Pt sheet and an Ag/AgCl (4M KCl) reference electrode.

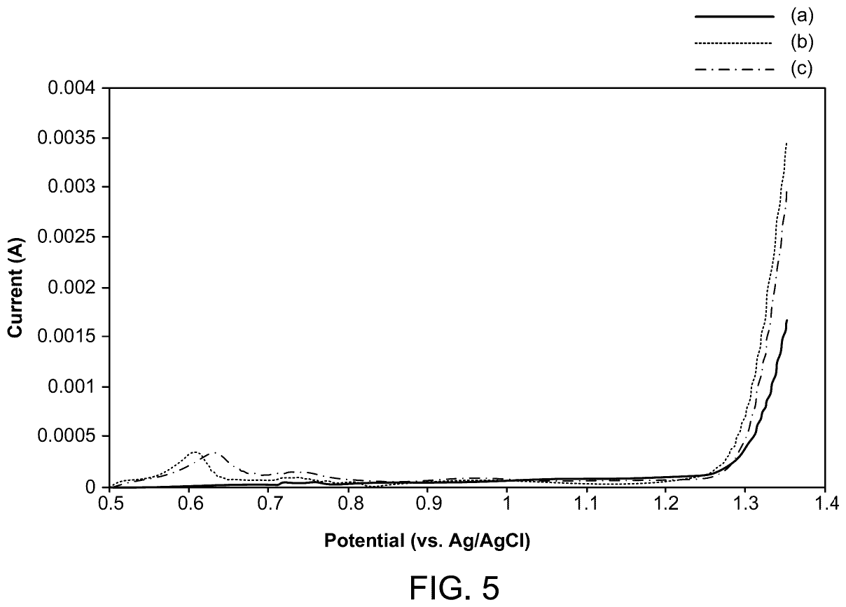

A linear sweep voltammetry (LSV) measurement in the range of 0.5 to 1.36 V (vs. Ag/AgCl) with a 10 mV/s rate was conducted, and the results for all three samples are compiled in FIG. 5. In a LSV measurement, the current, which is a measure of oxygen evolution reaction rate, is measured when scanning the voltage applied to the working electrode, which is a measure of energy applied into the reaction. An ideal OER catalyst has as a high current at a low applied voltage, for example the catalyst can achieve 10 mA/cm² at an overpotential of 250 mA. As shown in FIG. 5, the IrOₓ-cysteamine catalyst has the best OER activity because it has the highest OER current at any applied cell voltage (vs. Ag/AgCl) in the measured range. The commercial IrO₂ is the least active catalyst because it exhibits the lowest OER current at any applied cell voltage. Another notable feature for the two new Ir-based catalysts is the redox event occurring at 0.5-0.8 V applied voltage (vs. Ag/AgCl). This is believed to be due to the oxidation of Ir-related species, which is indicative of the catalyst being IrOₓ.

It should be noted that the potential range is catalyst related. Because the present catalysts are highly active, the potential can be stopped at 1.36 V. However, less active catalysts may need a higher potential to obtain measurable current.

### Example 4: Water Electrolysis Performance Evaluation of Three Iridium-Based Catalysts

The water electrolysis performance of a commercial IrO₂ catalyst and the two new catalysts made in Examples 1 and 2 were evaluated using a single water electrolysis cell at 80° C., atmospheric pressure.

A commercial IrO₂ catalyst-coated membrane, an IrOₓ-cysteamine catalyst-coated membrane, and an IrOₓ-bipyridine catalyst were prepared using a perfluorosulfonic acid polymer-based membrane with a thickness of 55 μm, a commercial Pt/C catalyst as the cathode coating layer on one side of the membrane for the hydrogen evolution reaction (HER), and the commercial IrO₂ catalyst (or the IrOₓ-cysteamine thin nanoplate catalyst, or the IrOₓ-bipyridine thin nanoplate catalyst) as the anode coating layer on the other side of the membrane for the OER, respectively. The Ir loading and Pt loading on the commercial IrO₂ catalyst-coated membrane were 0.9 mg/cm² and 0.15 mg/cm², respectively. The Ir loading and Pt loading on the IrOₓ-cysteamine catalyst-coated membrane was 0.15 mg/cm² and 0.15 mg/cm², respectively. The Ir loading and Pt loading on the IrOₓ-bipyridine catalyst-coated membrane was 0.15 mg/cm² and 0.15 mg/cm², respectively. The catalyst-coated membrane was sandwiched between two Pt-coated Ti-felt as the anode and cathode porous transport layers to form the catalyst-coated membrane electrode assembly. Then, the testing cell was installed using the catalyst-coated membrane electrode assembly.

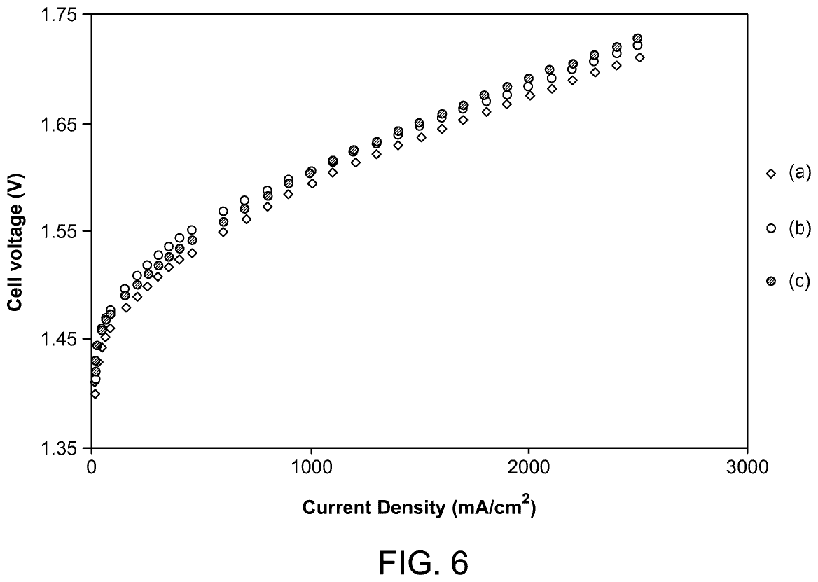

A proton exchange membrane (PEM) water electrolysis test station (Scribner 600 electrolyzer test system) was used to evaluate the water electrolysis performance of the commercial IrO₂ catalyst-coated membrane electrode assembly, the IrOₓ-cysteamine catalyst-coated membrane electrode assembly, and the IrOₓ-bipyridine catalyst-coated membrane electrode assembly in a single electrolyzer cell with an active membrane area of 5 cm². Porous transport layers (PTLs) and compression factors, defined as ratio between sealing gasket thickness and PTL thickness, were identical between these assemblies. The test station included an integrated power supply, a potentiostat, an impedance analyzer for electrochemical impedance spectroscopy (EIS) and high-frequency resistance (HFR), and real-time sensors for product flow rate and cross-over monitoring. The testing was conducted at 80° C. and at 15 psig pressure. ultrapure water was supplied to the anode of the cell with a flow rate of 100 mL/min. The polarization curve was prepared (each datapoint end of 1 min hold) as shown in FIG. 6.

FIG. 6 shows that the IrOₓ-cysteamine catalyst-coated membrane electrode assembly and IrOₓ-bipyridine catalyst catalyst-coated membrane electrode assembly with very low Ir loading of 0.15 mg/cm² showed water electrolysis performance comparable to a commercial IrO₂ catalyst-coated membrane electrode assembly with higher Ir loading of about 1.0 mg/cm² as evident from the comparable current density at equal voltages.

### SPECIFIC EMBODIMENTS

While the following is described in conjunction with specific embodiments, it will be understood that this description is intended to illustrate and not limit the scope of the preceding description and the appended claims.

A first embodiment of the invention is an iridium-based catalyst comprising a catalytic material comprising nanoplates comprising iridium oxide or a mixture of iridium and iridium oxide and having a BET surface area of at least 50 m²/g and a pore volume of at least 0.10 cc/g, and wherein a thickness of the nanoplates is less than 50 nm. An embodiment of the invention is one, any or all of prior embodiments in this paragraph up through the first embodiment in this paragraph wherein the thickness of the nanoplates is less than 20 nm. An embodiment of the invention is one, any or all of prior embodiments in this paragraph up through the first embodiment in this paragraph wherein the thickness of the nanoplates is less than 10 nm. An embodiment of the invention is one, any or all of prior embodiments in this paragraph up through the first embodiment in this paragraph wherein the BET surface area is at least 100 m²/g. An embodiment of the invention is one, any or all of prior embodiments in this paragraph up through the first embodiment in this paragraph wherein the BET surface area is at least 150 m²/g. An embodiment of the invention is one, any or all of prior embodiments in this paragraph up through the first embodiment in this paragraph wherein the BET surface area is in a range of 50 m²/g to 800 m²/g. An embodiment of the invention is one, any or all of prior embodiments in this paragraph up through the first embodiment in this paragraph wherein the BET surface area is in a range of 50 m²/g to 300 m²/g. An embodiment of the invention is one, any or all of prior embodiments in this paragraph up through the first embodiment in this paragraph wherein the pore volume of at least 0.20 cc/g. An embodiment of the invention is one, any or all of prior embodiments in this paragraph up through the first embodiment in this paragraph wherein the pore volume of at least 0.30 cc/g. An embodiment of the invention is one, any or all of prior embodiments in this paragraph up through the first embodiment in this paragraph wherein the pore volume is in a range of 0.10 cc/g to 0.70 cc/g. An embodiment of the invention is one, any or all of prior embodiments in this paragraph up through the first embodiment in this paragraph wherein the pore volume is in a range of 0.10 cc/g to 0.40 cc/g. An embodiment of the invention is one, any or all of prior embodiments in this paragraph up through the first embodiment in this paragraph wherein the BET surface area is in a range of 50 m²/g to 800 m²/g and the pore volume is in a range of 0.20 cc/g to 0.70 cc/g.

A second embodiment of the invention is a method of making an iridium-based nanoplate catalyst comprising providing a solution of an iridium-based precursor in a solvent; adding an organic structure directing template and an inorganic structure directing template to the solution; heating the solution with the organic and inorganic structure directing templates and evaporating the solvent forming a solid residue; drying the solid residue; and calcining the solid residue to form an iridium-based catalyst comprising iridium oxide or a mixture of iridium and iridium oxide thin nanoplates and having a BET surface area of at least 50 m²/g and a pore volume of at least 0.10 cc/g, and wherein a thickness of the nanoplate is less than 50 nm. An embodiment of the invention is one, any or all of prior embodiments in this paragraph up through the second embodiment in this paragraph wherein the organic structure directing template comprises cysteamine, 2,2′-bipyridine, terpyridne, tris(2-aminoethyl)amine, ethylenediamine, 3-aminopropane-1-thiol, glycine, ethanolamine, polyethylene imine, or combinations thereof. An embodiment of the invention is one, any or all of prior embodiments in this paragraph up through the second embodiment in this paragraph wherein the inorganic structure directing template comprises NaNO₃, KNO₃, LiNO₃, NaCl, KCl or combinations thereof. An embodiment of the invention is one, any or all of prior embodiments in this paragraph up through the second embodiment in this paragraph wherein the solution with the organic and inorganic structure directing templates is heated at a temperature in the range of 300° C. to 900° C. for 10 min to 240 min. An embodiment of the invention is one, any or all of prior embodiments in this paragraph up through the second embodiment in this paragraph wherein the solid residue is dried at a temperature of in the range of 350° C. to 650° C. for 20 min to 120 min. An embodiment of the invention is one, any or all of prior embodiments in this paragraph up through the second embodiment in this paragraph wherein the solid residue is calcined at a temperature of in the range of 400° C. to 500° C. for 30 min to 60 min. An embodiment of the invention is one, any or all of prior embodiments in this paragraph up through the second embodiment in this paragraph further comprising washing the iridium-based catalyst with water, or an organic solvent, or combinations thereof. An embodiment of the invention is one, any or all of prior embodiments in this paragraph up through the second embodiment in this paragraph wherein the BET surface area is in a range of 50 m²/g to 800 m²/g, or the pore volume is in a range of 0.20 cc/g to 0.70 cc/g, or both.

Without further elaboration, it is believed that using the preceding description that one skilled in the art can utilize the present invention to its fullest extent and easily ascertain the essential characteristics of this invention, without departing from the spirit and scope thereof, to make various changes and modifications of the invention and to adapt it to various usages and conditions. The preceding preferred specific embodiments are, therefore, to be construed as merely illustrative, and not limiting the remainder of the disclosure in any way whatsoever, and that it is intended to cover various modifications and equivalent arrangements included within the scope of the appended claims.

In the foregoing, all temperatures are set forth in degrees Celsius and, all parts and percentages are by weight, unless otherwise indicated.

What is claimed is:

1. An iridium-based catalyst comprising:
a catalytic material comprising nanoplates comprising iridium oxide or a mixture of iridium and iridium oxide and having a BET surface area of at least 50 m²/g and a pore volume of at least 0.10 cc/g, and wherein a thickness of the nanoplates is less than 50 nm.

2. The catalyst of claim 1 wherein the thickness of the nanoplates is less than 20 nm.

3. The catalyst of claim 1 wherein the thickness of the nanoplates is less than 10 nm.

4. The catalyst of claim 1 wherein the BET surface area is at least 100 m²/g.

5. The catalyst of claim 1 wherein the BET surface area is at least 150 m²/g.

6. The catalyst of claim 1 wherein the BET surface area is in a range of 50 m²/g to 800 m²/g.

7. The catalyst of claim 1 wherein the BET surface area is in a range of 50 m²/g to 300 m²/g.

8. The catalyst of claim 1 wherein the pore volume of at least 0.20 cc/g.

9. The catalyst of claim 1 wherein the pore volume of at least 0.30 cc/g.

10. The catalyst of claim 1 wherein the pore volume is in a range of 0.10 cc/g to 0.70 cc/g.

11. The catalyst of claim 1 wherein the pore volume is in a range of 0.10 cc/g to 0.40 cc/g.

12. The catalyst of claim 1 wherein the BET surface area is in a range of 50 m²/g to 800 m²/g and the pore volume is in a range of 0.20 cc/g to 0.70 cc/g.

13. A method of making an iridium-based nanoplate catalyst comprising:
providing a solution of an iridium-based precursor in a solvent;
adding an organic structure directing template and an inorganic structure directing template to the solution;
heating the solution with the organic and inorganic structure directing templates and evaporating the solvent forming a solid residue;
drying the solid residue; and
calcining the solid residue to form an iridium-based catalyst comprising iridium oxide or a mixture of iridium and iridium oxide thin nanoplates and having a BET surface area of at least 50 m²/g and a pore volume of at least 0.10 cc/g, and wherein a thickness of the nanoplate is less than 50 nm.

14. The method of claim 13 wherein the organic structure directing template comprises cysteamine, 2,2′-bipyridine, terpyridne, tris(2-aminoethyl)amine, ethylenediamine, 3-aminopropane-1-thiol, glycine, ethanolamine, polyethylene imine, or combinations thereof.

15. The method of claim 13 wherein the inorganic structure directing template comprises NaNO₃, KNO₃, LiNO₃, NaCl, KCl or combinations thereof.

16. The method of claim 13 wherein the solution with the organic and inorganic structure directing templates is heated at a temperature in the range of 300° C. to 900° C. for 10 min to 240 min.

17. The method of claim 13 wherein the solid residue is dried at a temperature of in the range of 350° C. to 650° C. for 20 min to 120 min.

18. The method of claim 13 wherein the solid residue is calcined at a temperature of in the range of 400° C. to 500° C. for 30 min to 60 min.

19. The method of claim 13 further comprising:
washing the iridium-based catalyst with water, or an organic solvent, or combinations thereof.

20. The catalyst of claim 13 wherein the BET surface area is in a range of 50 m²/g to 800 m²/g, or the pore volume is in a range of 0.20 cc/g to 0.70 cc/g, or both.
